(19) United States
(12) Patent Application Publication
(10) Pub. No.: US 2006/0077201 A1
(43) Pub. Date: Apr. 13, 2006

(54) SYNCHRONOUS IMAGE-SWITCHING DEVICE AND METHOD THEREOF

(76) Inventor: Chung-Li Shen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,743

(22) Filed: Apr. 14, 2005

(30) Foreign Application Priority Data
Oct. 12, 2004 (TW) 93130842

(51) Int. Cl. G09G 5/00

(52) U.S. Cl. 345/213

(57) ABSTRACT

A synchronous image-switching device and switching method thereof are provided. The synchronous image-switching device comprises an image filter for generating target image data according to the frequency of a first clocking signal, a buffer for holding the target image and an image output control device for outputting the target image according to the frequency of a second clocking signal. Because the synchronous switching device of the present invention allows the clocking frequency of the source image to be different from that of the target image, images can be switched synchronously and power consumption of the switching operation can be reduced.

### CROSS-REFERENCE TO RELATED APPLICATION

This application claims the priority benefit of Taiwan application serial no. 93130842, filed on Oct. 12, 2004. All disclosure of the Taiwan application is incorporated herein by reference.

### BACKGROUND OF THE INVENTION

1. Field of the Invention

The present invention relates to an image-switching device. More particularly, the present invention relates to a synchronous image-switching device.

2. Description of the Related Art

Due to the rapid development of display devices, electronic screens are applied to various electronic products including digital cameras, liquid crystal display (LCD) televisions and liquid crystal display (LCD) monitors. In general, the displayed image and the image source have different resolutions so that the user would not know if the resolution of the next image data matches the pre-set resolution in the current system. Therefore, the user could not determine if any adjustment in the resolution is required before display.

To deal with this problem, manufacturers are working to find a technique for automatically switching the resolution of images. Due to the different resolution of image sources, resolution adjustment must be carried out following a specific ratio between the clocking signal of the raw image source and the clocking signal of the target image. An example of this technique can be found in U.S. Pat. Nos. 5,739,867 and 6,002,446. However, in the aforementioned patent, the image resolution switching module must operate at the higher frequency between the source signal and the target signal. Hence, the power consumption is higher and may bring users some inconvenience. Thus, finding a synchronous switching device capable of operating at a lower frequency is desired.

### SUMMARY OF THE INVENTION

Accordingly, one object of the present invention is to provide a synchronous image-switching device capable of switching images synchronously with low power consumption.

A second object of the present invention is to provide a synchronous switching method capable of switching images synchronously.

To achieve these and other advantages and in accordance with the purpose of the invention, as embodied and broadly described herein, the invention provides a synchronous switching device for images. The synchronous switching device comprises an image-filtering device, a buffer and an image output control device. The image-filtering device receives a raw image according to the frequency of a first clocking signal to generate and output a target image. The buffer holds the target image outputted from the image-filtering device. The image output control device controls the target image saved in the buffer outputted from the buffer according to the frequency of a second clocking signal.

The present invention also provides a synchronous switching method for images. The synchronous switching method includes the following steps. First, a raw image is acquired using the frequency of a first clocking signal. According to the frequency of the first clocking signal, the pixel of the raw image is referred to generate the pixel of a target image. Furthermore, according to the frequency of the first clocking signal, the pixel of the target image are transmitted to a buffer. Finally, according to the frequency of a second clocking signal, the pixel of the target image are retrieved from the buffer.

In the present invention, the clocking signal of the image source and the clocking signal of the image destination are not necessarily related and a lower operating frequency is used. Accordingly, synchronous switching can be carried out at a relatively low power consumption.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing a synchronous image-switching device according to one embodiment of the present invention.

FIG. 2 is a block diagram showing the horizontal and vertical interpolation module of a synchronous image-switching device according to one embodiment of the present invention.

FIG. 3 is a block diagram showing the horizontal and vertical decimation module of a synchronous image-switching device according to one embodiment of the present invention.

FIG. 4 is a block diagram showing a synchronous image-switching method according to one embodiment of the present invention.

FIG. 5 is a block diagram showing the format output module of a synchronous image-switching device according to one embodiment of the present invention.

FIG. 6 is a diagram showing the waveform of various parameters inputted in the format output module of a synchronous image-switching device according to one embodiment of the present invention.

FIG. 7 is a diagram showing the waveform of various parameters outputted from the format output module of a synchronous image-switching device according to one embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

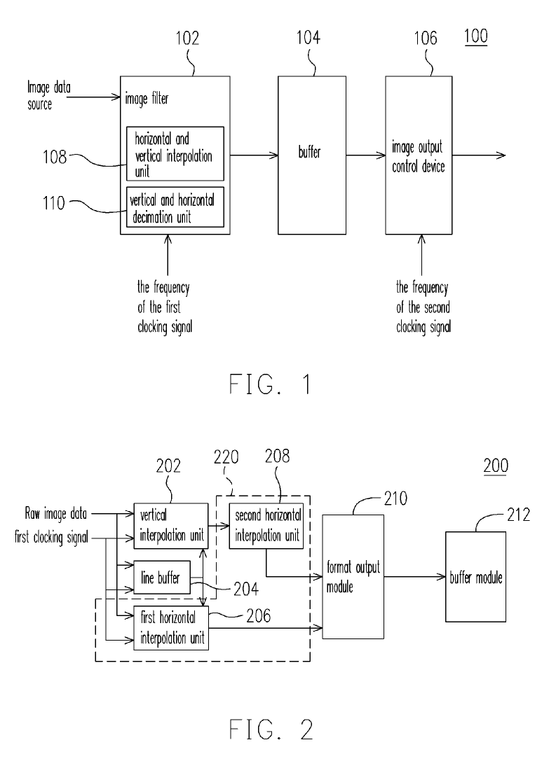

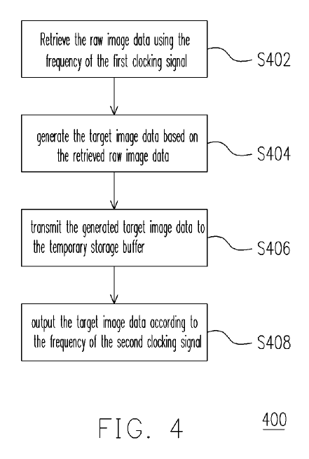

For a clear understanding of the technique provided by the present invention, please refer to FIGS. 1 and 4. FIG. 1 is a block diagram showing a synchronous image-switching device according to one embodiment of the present invention. FIG. 4 is a block diagram showing a synchronous image-switching method according to one embodiment of the present invention. The synchronous image-switching device 100 comprises an image filter 102, a buffer 104 and an image output control device 106. The image filter 102 is electrically coupled to the input terminal of the buffer 104 and the output terminal of the buffer is electrically coupled to the image output control device 106.

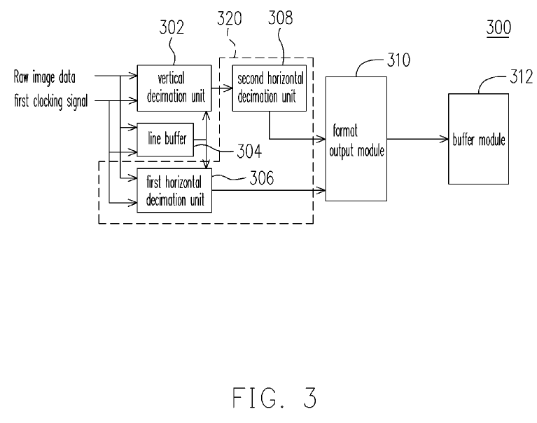

As shown in FIG. 1, a first clocking signal and a second clocking signal are inputted to the image filter 102 and the image output control device 106, respectively. In general, the frequency of the first clocking signal is not directly related with the frequency of the second clocking signal. The image filter 102 receives raw image data from the input terminal according to the frequency of the first clocking signal and generates and outputs corresponding target image data using the frequency of the first clocking signal as the operating frequency (in step S402). To achieve the aforementioned function, the image filter 102 utilizes either interpolation or decimation or both techniques. In other words, the image filter 102 may further comprise a horizontal or vertical interpolation module 200 (as shown in FIG. 2) and/or a horizontal or vertical decimation module 300 (as shown in FIG. 3). Through the interpolation module 200 and the decimation module 300, the image filter 102 is able to generate and output target image data according to the input raw image data.

FIG. 2 is a block diagram showing a horizontal or vertical interpolation module 200 of a synchronous image-switching device according to one embodiment of the present invention. The horizontal or vertical interpolation module 200 comprises a vertical interpolation unit 202, a line buffer 204 a horizontal interpolation unit 220 (comprising a first horizontal interpolation unit 206 and a second horizontal interpolation unit 208 in the present embodiment), a format output module 210 and a buffer module 212. Although the horizontal or vertical interpolation module 200 in the present embodiment includes both vertical interpolation unit 202 and horizontal interpolation unit 220, one of the two units 202 and 220 might be omitted from the module 200 when only another one of them is attempted to be used.

The raw image data and the first clocking signal are inputted into the input terminal of the vertical interpolation unit 202, the line buffer 204 and the first horizontal interpolation unit 206, respectively. The output terminal of the vertical interpolation unit 202 is electrically coupled to the input terminal of the second horizontal interpolation unit 208. The output terminal of the line buffer 204 is electrically coupled between the other input terminal of the vertical interpolation unit 202 and the first horizontal interpolation unit 206. The output terminal of the second horizontal interpolation unit 208 and the output terminal of the first horizontal interpolation unit 206 are electrically coupled to the input terminal of the format output module 210. The output terminal of the format output module 210 is electrically coupled to the input terminal of the buffer module 212. In the present embodiment, the buffer line 204 can store at least an image source data. The image source data are submitted to the vertical interpolation unit 202 or the first horizontal interpolation unit 206 to serve as operational data for generating interpolation pixels.

In the present embodiment, when the amount of raw image data pixels displayed in unit time is smaller than that of target image data pixels displayed in unit time, the horizontal or vertical interpolation module 200 is activated. The first horizontal interpolation unit 206 operates when the horizontal resolution of the raw image data and the end display device are different. The first horizontal interpolation unit 206 provides additional display pixels to each received scan line so that the number of pixels in each processed scan line exactly matches the horizontal resolution of the end display device. The processed scan lines are outputted to the format output module 210.

Similarly, when the vertical resolution of the raw image data and that of the end display device are different, the vertical interpolation unit 202 will provide additional display lines (that is, vertical interpolation pixels) at suitable locations between the display lines based on the difference between vertical resolution of the raw image data and the end display device. Consequently, the number of vertical pixel point (the number of scan lines) in the image data matches that on the end display device. Finally, the additional vertical interpolation pixels are outputted.

The scan lines produced through the vertical interpolation unit 202 are outputted to the second horizontal interpolation unit 208. According to the difference in horizontal resolution between the raw image data and the end display device, the second horizontal interpolation unit 208 inserts additional horizontal pixel points (horizontal interpolation pixels) at suitable locations in the received scan lines. Hence, the number of horizontal pixel points in the newly generated scan lines exactly matches that of the end display device. Finally, the results are transmitted to the format output module 210.

The format output module 210 receives the data from the horizontal interpolation unit 220 and outputs the data to the buffer 104 according to the frequency of the first clocking signal. A higher operating frequency is not used to output data from the format output module 210 when the number of display pixels per unit time in the end display device is larger than that of display pixels per unit time in the original raw image. Instead, the format output module 210 still uses the original frequency of the first clocking signal to output data. However, a wider frequency band is used to increase the amount of data output per unit time.

For example, if the vertical resolution of the raw image data is Vm, the horizontal resolution is Hn, the number of pictures displayed per second (or picture display rate) is S1, then the number of raw images displayed per unit time is Vm×Hn×S1. Similarly, if the vertical resolution of the end display device is Vp, the horizontal resolution is Hq and the picture display rate is S2, the number of pictures displayed by the end display device per unit time is Vp×Hq×S2. Under these circumstances, if the input frequency bandwidth for the raw image data is B1 bits, the data output bandwidth B2 of the format output module 210 must have at least a value derived from the following formula: B2=(Vp×Hq×S2)/(Vm×Hn×S1).

When the picture display rate of the raw image and the end display device are identical (S1=S2), there is no need for the image filter 102 to provide additional pictures. However, if the picture display rate between the raw image and the end display device is different, the image filter 102 needs to have more image data generation circuits operating at the frequency of the first clocking signal to generate additional picture scenes. These additional image data generation circuits can be the aforementioned vertical interpolation unit 202 and the horizontal interpolation unit 220 and hence detailed description is not repeated. Through the additional image data generation circuits, the pixel output rate of the format output module 210 is high enough for the end display device.

Accordingly, with the vertical interpolation unit 202, the first horizontal interpolation unit 206, the second horizontal interpolation unit 208 and the format output module 210, the present invention is able to generate the target image data for the end display device (in step S404) and output the target image data (in step S406) at a low operating frequency.

The image output control device 106 retrieves the target image stored in the buffer 104 according to the frequency of the second clocking signal for display images on the end display device and outputs the images to the end display device (in step S408).

FIG. 3 is a block diagram showing a horizontal or vertical decimation module 300 of a synchronous image-switching device according to one embodiment of the present invention. The horizontal or vertical decimation module 300 comprises a vertical decimation unit 302, a line buffer 304, a horizontal decimation unit 320 (comprising a first horizontal decimation unit 306 and a second horizontal decimation unit 308 in the present embodiment), a format output module 310 and a buffer module 312. Likely, although the horizontal or vertical decimation module 300 in the present embodiment includes both vertical decimation unit 302 and horizontal decimation unit 320, one of the two units 302 and 320 might be omitted from the module 300 when only another one of them is attempted to be used.

The raw image data and the first clocking signal are inputted to the input terminal of the vertical decimation unit 302, the line buffer 304 and the first horizontal decimation unit 306, respectively. The output terminal of the vertical decimation unit 302 is electrically coupled to the input terminal of the second horizontal decimation unit 308. The output terminal of the line buffer 304 is electrically coupled to the other input terminal of the vertical decimation unit 302 and the first horizontal decimation unit 306. The output terminal of the second horizontal decimation unit 308 and the output terminal of the first horizontal decimation unit 306 are electrically coupled to the input terminal of the format output module 310. The output terminal of the format output module 310 is electrically coupled to the input terminal of the buffer module 312. In the present embodiment, the image source data are submitted to the vertical decimation unit 302 or the first horizontal decimation unit 306 to serve as operational data for generating decimation pixels.

In the present embodiment, when the amount of raw image data pixels displayed in unit time is larger than that of target image data pixels displayed in unit time, the horizontal or vertical decimation module 300 is activated. The first horizontal decimation unit 306 operates when the horizontal resolution of the raw image data and the end display device is different. The first horizontal decimation unit 306 removes redundant display pixels from each received scan line so that the number of pixels in each processed scan line exactly matches the horizontal resolution of the end display device. The processed scan lines are outputted to the format output module 310.

Similarly, when the vertical resolution of the raw image data and the end display device is different, the vertical decimation unit 302 will remove redundant display lines (that is, remove vertical pixel points) at suitable locations between the display lines. The display lines are deleted according to the difference in the resolution of the vertical display pixels between the raw image data and end display device. Consequently, the number of vertical pixel point (the number of scan lines) in the image data matches the resolution of the end display device. Finally, the deleted vertical pixels are outputted from the vertical decimation unit 302.

The scan lines produced through the vertical decimation unit 302 are inputted to the second horizontal decimation unit 308. According to the difference in horizontal resolution between the raw image data and the end display device, the second horizontal decimation unit 308 deletes redundant horizontal pixel points (deleted horizontal pixels) at suitable locations in the received scan lines. Hence, the number of horizontal pixel points in the newly generated scan lines exactly matches that of the end display device. Finally, the results are transmitted to the format output module 310.

The format output module 310 receives the data from the horizontal decimation unit 320 and outputs the data to the buffer 104 according to the frequency of the first clocking signal. A higher operating frequency is not used to output data from the format output module 310 when the number of display pixels per unit time in the end display device is smaller than that in the original raw image. Instead, the format output module 310 still uses the original frequency of the first clocking signal to output data. However, a wider frequency band is used to increase the amount of data output per unit time.

For example, if the vertical resolution of the raw image data is Vm, the horizontal resolution is Hn, the number of pictures displayed per second (or picture display rate) is S1, then the number of raw images displayed per unit time is Vm×Hn×S1. Similarly, if the vertical resolution of the end display device is Vp, the horizontal resolution is Hq and the picture display rate is S2, then the number of pictures displayed by the end display device per unit time is Vp×Hq×S2. Under these circumstances, if the input frequency bandwidth for the raw image data is B1 bits, the data output bandwidth B2 of the format output module 310 must have at least a value derived from the following formula: B2=(Vp×Hq×S2)/(Vm×Hn×S1).

When the picture display rate of the raw image and the end display device are identical (S1=S2), there is no need for the image filter 102 to delete redundant pictures. However, if the picture display rate of the raw image is higher than that of the end display device, there is no need for the image filter 102 to have more image data generation circuits operating at the frequency of the first clocking signal to generate additional picture scenes. The image data generation circuits can be the aforementioned vertical decimation unit 302 and the horizontal decimation unit 320 and hence a detailed description is not repeated. Through the image data generation circuits, the pixel output rate of the format output module 310 is enough for the end display device.

The two modules 200 and 300 described above can be simultaneously used in one application. In other words, the raw image may be interpolated on the horizontal direction and decimated on the vertical direction, or the raw image may be decimated on the horizontal direction and interpolated on the vertical direction.

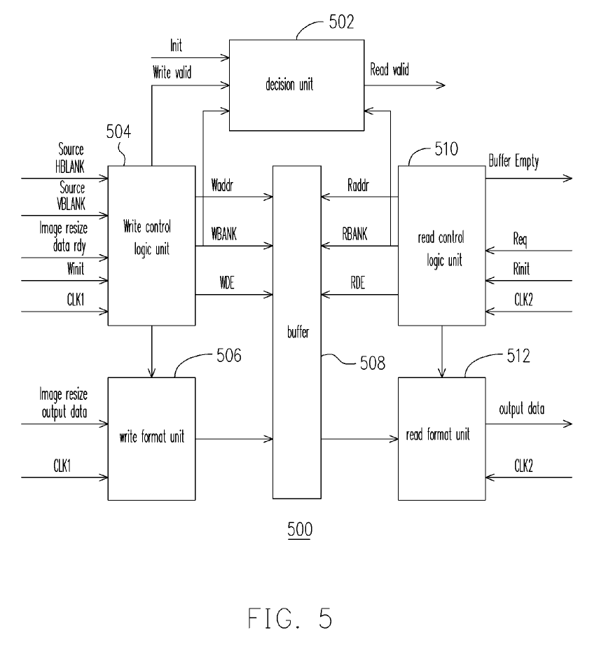

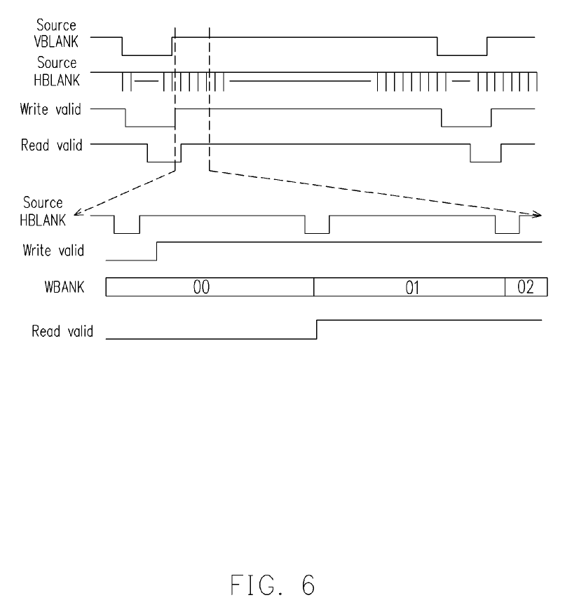

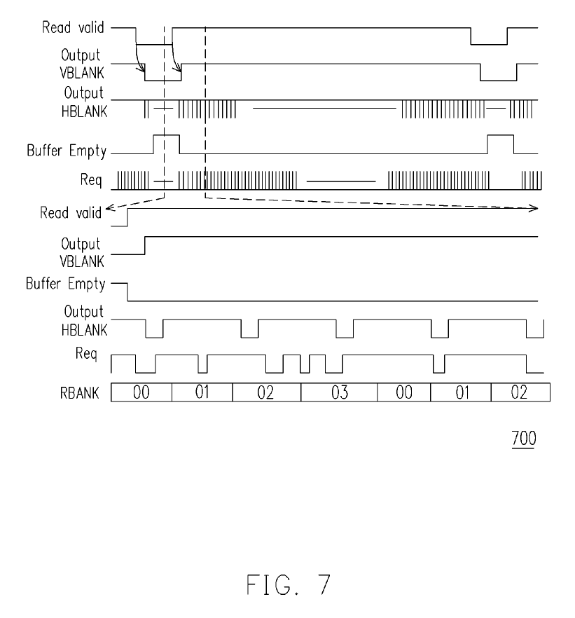

Please refer to FIGS. 5, 6, and 7. FIG. 5 is a block diagram showing the format output module of a synchronous image-switching device according to one embodiment of the present invention. FIG. 6 is a diagram showing the waveform of various parameters inputted in the format output module of a synchronous image-switching device according to one embodiment of the present invention. FIG. 7 is a diagram showing the waveform of various parameters outputted from the format output module of a synchronous image-switching device according to one embodiment of the present invention. As shown in FIG. 5, the format output module circuit 500 comprises a decision unit 502, a write control logic circuit 504, a write format unit 506, a buffer 508, a read control logic circuit 510 and a read format unit 512.

The memory select line WBANK, the data address lines (Waddr, Raddr) and the data enable lines (WDE, RDE) of the write control logic unit 504 and the read control logic unit 510 are electrically coupled to the buffer 508, respectively. The memory select line WBANK is also electrically coupled to the decision unit 502. The write control logic unit 504 is electrically coupled to the write format unit 506 and the read control logic unit 510 is electrically coupled to the read format unit 512 to control the write format unit 506 and the read format unit 512. The write format unit 506 outputs the data to the buffer 508 and then the buffer 508 outputs the data according to the request from the read format unit 512.

In the present embodiment, the write control logic unit 504 receives the horizontal pixel signal (Source HBLANK) and the vertical pixel signal (Source VBLANK) of the image source data, the first clocking signal (CLK1) and the data ready signal (Rdy) provided by the image filter 102. After the output data from the image filter 102 are transmitted to the write format unit 506, where the data with appropriate width format are generated, the processed data are then outputted to the buffer 508 under the control of write control logic unit 504.

The write control logic unit 504 also outputs a write valid signal to the decision unit 502 informing the decision unit 502 that data have already written into the buffer 508. Thereafter, the decision unit 502 outputs a read valid signal to the image output control device 106. Upon receiving the read valid signal, the image output control device 106 generates a request signal (Req) to the read control logic unit 510 so that the read control logic unit 510 can control the read format unit 512 to read image data from the buffer 508.

FIG. 6 is a diagram showing the waveform of various parameters input into the format output module of a synchronous image-switching device according to one embodiment of the present invention. As shown in FIG. 6, the relationship among the horizontal pixel signal and the vertical pixel signal, the write valid signal and the read valid signal can be observed.

To transmit the horizontal pixel signal (Source HBLANK) of the image source data and the vertical pixel signal (Source VBLANK) of the image source data to the buffer 508, the wave cycle of the horizontal pixel signal of the image source data and the vertical pixel signal of the image source data and the wave cycle of the write valid signal are at the upper edge triggering positions so that the write control logic unit 504 can control the write format unit 506 to write the horizontal pixel and the vertical pixel of the image source data into the buffer 508.

FIG. 7 is a diagram showing the waveform of various parameters output from the format output module of a synchronous image-switching device according to one embodiment of the present invention. As shown in FIG. 7, the relationship between the output horizontal image data signal and the vertical image data signal, the data request signal and the read valid signal can be observed.

When the image output control device 106 needs to read the horizontal image data and the vertical image data from the buffer 508, a request signal is submitted to the read control logic unit 510. Accordingly, when the wave cycle of the horizontal line of the image source data and the wave cycle of the vertical line of the image source data, and the wave cycle of the read valid signal and the request signal are at the upper edge triggering position, the read control logic unit 510 can control the read format unit 512 to read image data from the buffer 508 and output to the image output control device 106.

In summary, through interpolation and decimation of the data points of vertical pixels as well as the interpolation and decimation of the data points of horizontal pixels, the present invention is able to lower the operating frequency and achieve synchronous image-switching at relatively low power consumption.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A synchronous image-switching device for converting a raw image having a first resolution and a first picture display rate into a target image having a second resolution and a second picture display rate, the device comprising:
an image filter, operating according to a frequency of a first clocking signal, wherein the image filter receives the raw image and generates the target image according to the raw image;
a buffer, for holding the target image; and
an image output control device, for controlling the buffer to output the target image according to a frequency of a second clocking signal,
wherein the image filter synchronously outputs a plurality of pixels to the buffer at least once when an amount of the raw image pixels displayed per unit time is smaller than that of the target image pixels displayed image per unit time.

2. The synchronous image-switching device of claim 1, wherein the image filter further comprises:
a line buffer for holding the raw image;
a horizontal interpolation module for generating a horizontal interpolation pixel;
a vertical interpolation module for generating a vertical interpolation pixel; and
a format output module for assembling the raw image, the horizontal interpolation pixels and the vertical interpolation pixels into the target image.

3. The synchronous image-switching device of claim 1, wherein the image filter further comprises:
a line buffer, for holding the raw image;
a horizontal decimation module, for deleting a horizontal pixel from the raw image;
a vertical decimation module, for deleting a vertical pixel from the raw image; and
a format output module, for outputting the target image formed after deleting the horizontal pixel and the vertical pixel from the raw image.

4. A synchronous image-switching method for converting a raw image having a first resolution and a first picture display rate into a target image having a second resolution and a second picture display rate, the method comprising the steps of:
retrieving the raw image using a frequency of a first clocking signal;
generating a pixel of the target image based on a pixel of the raw image according to the frequency of the first clocking signal;
transmitting the pixel of the target image to a buffer according to the frequency of the first clocking signal; and
outputting the pixel of the target image from the buffer according to the frequency of a second clocking signal,
wherein the image filter outputs another pixel to the buffer in synchronization with the pixel sent to the buffer at least once when the amount of the raw image pixels displayed per unit time is smaller than that of the target image pixels displayed per unit time.

5. The synchronous image-switching method of claim 4, wherein the step of generating the pixel of the target image further comprises:
generating an interpolation pixel synchronously during the pixels of the target image are converted from the pixels of the raw image when a total amount of the raw image pixels displayed is smaller than that of the target image pixels displayed; and
decimating pixel from the target image in the process of converting the pixels of the raw data into the pixels of the target image when the total amount of the raw image pixels displayed is more than that of the target image pixels displayed.

6. The synchronous image-switching method of claim 4, wherein the step of generating the pixel of the target image further comprises:
generating an interpolation pixel synchronously during the pixels of the target image are converted from the pixels of the raw image when a total amount of the raw image pixels displayed is smaller than that of the target image pixels displayed.

7. The synchronous image-switching method of claim 4, wherein the step of generating the pixel of the target image further comprises:
decimating pixel from the target image in the process of converting the pixels of the raw data into the pixels of the target image when the total amount of the raw image pixels displayed is more than that of the target image pixels displayed.

8. The synchronous image-switching method of claim 4, wherein the step of generating the pixel of the target image further comprises:
generating an interpolation scan line for the target image using the scan lines of the image data at least once synchronously during the process of converting the scan lines of the raw image into the scan lines of the target image when a total amount of the raw image pixels displayed is smaller than that of the target image pixels displayed; and
decimating one of the scan lines of the raw image at least once when the total amount of the raw image pixels displayed is more than that of the target image pixels displayed.

9. The synchronous image-switching method of claim 4, wherein the step of generating the pixel of the target image further comprises:
generating an interpolation scan line for the target image using the scan lines of the image data at least once synchronously during the process of converting the scan lines of the raw image into the scan lines of the target image when a total amount of the raw image pixels displayed is smaller than that of the target image pixels displayed.

10. The synchronous image-switching method of claim 4, wherein the step of generating the pixel of the target image further comprises:
decimating one of the scan lines of the raw image at least once when the total amount of the raw image pixels displayed is more than that of the target image pixels displayed.
